(19) United States
(12) Patent Application Publication
(10) Pub. No.: US 2014/0223575 A1
(43) Pub. Date: Aug. 7, 2014

(54) PRIVACY PROTECTION IN RECOMMENDATION SERVICES

(71) Applicants: Animesh Nandi, Kolkata (IN); Armen Aghasaryan, Nozay (FR); Makram Bouzid, Nozay (FR)

(72) Inventors: Animesh Nandi, Kolkata (IN); Armen Aghasaryan, Nozay (FR); Makram Bouzid, Nozay (FR)

(73) Assignee: ALCATEL LUCENT, Paris (FR)

(21) Appl. No.: 14/113,936

(22) PCT Filed: Apr. 17, 2012
(86) PCT No.: PCT/EP2012/056982

§ 371 Date: Apr. 8, 2014

(30) Foreign Application Priority Data
Apr. 25, 2011 (IN) 1209/DEL/2011

(51) Int. Cl. H04L 29/06

(52) U.S. Cl. CPC H04L 63/104
USPC 726/27

(57) ABSTRACT

The present subject matter discloses a system and a method for privacy protection to protect the confidential and personal information of end users using a client device (108) to avail services recommended by a service provider (110). In one embodiment, a privacy protection system (102)for recommendation services comprises a processor (202) and a memory (204) coupled to the processor (204). The memory (204) comprises a interest group aggregator module (112) having at least one interest group aggregator, each of the at least one interest group aggregator configured to collate a plurality of segments of profile information pertaining to a plurality of end users categorized in a interest group based on a interest profile of each of the plurality of end users.

### FIELD OF INVENTION

The present subject matter relates to communication systems and, particularly but not exclusively, to privacy protection of end users in recommendation services.

### BACKGROUND

Owing to the huge mass of content available over the World Wide Web, end users accessing content provided by service providers are often provided assistance by the service providers in making a selection of content. Conventionally known techniques, such as content based recommendation, collaborative recommendation, etc., are used to generate recommendations to enable such selection by the end users. In content based recommendation, the end users are recommended content, services or products which are similar to the content, services or products used or liked by the end users in the past or which match the interest or choice of the end user. In collaborative recommendation, the end user is recommended content, services or products which are similar to the content, services or products used or liked by other users having similar or same interest or choices.

In an example of content based recommendation, a movie review website may monitor an end user to regularly view a certain category of movies, say animated movies. Accordingly, every time an animated movie is available for view, the end users may be provided a recommendation, such as a notification or an alert, for example, to download the movie by making relevant payments.

In another example, a search engine portal may monitor and collect information pertaining to the search query strings used by an end user and may recommend to the end user, alternate search query strings based on past results viewed by him.

Similarly, in collaborative recommendation, also known as collaborative filtering, service providers may provide targeted advertisements to an end user where these advertisements pertain to product or services that have been preferred by other end users that have similar interests and preferences as the end user. For example, an interne protocol television (IPTV) service provider may recommend television shows or movies to the end user, if the television shows or movies have been viewed by other end users whose interests match the interests of the end user.

In another example of collaborative recommendation, a web portal may recommend certain websites to the end user if the websites have been liked by other end users having an interest profile similar to that of the end user. Further, a service provider may suggest places to visit or places to dine at, etc., to an end user based on the places visited or reviewed by other end users having a similar interest profile.

### SUMMARY

This summary is provided to introduce concepts related to privacy protection of end users in recommendation services. This summary is not intended to identify essential features of the claimed subject matter nor is it intended for use in determining or limiting the scope of the claimed subject matter.

In an embodiment, a method for privacy protection in recommended services includes aggregating profile information associated with a plurality of interest profiles of one or more end users who have been categorized into various interest groups based on the end users' interest profiles. The method further includes determining one or more services availed by the at least one interest group based on the aggregated profile information and receiving recommended services for various interest groups based in part on the one or more availed services

In accordance with another embodiment of the present subject matter a method for privacy protected recommended services includes determining at least one interest group identity (id) based on an interest profile of an end user, wherein the at least one interest group identity pertains to at least one pre-defined interest group. The method further includes anonymously transmitting profile information associated with the interest profile of the end user to an interest group aggregator module associated with the at least one interest group identity.

In accordance with another embodiment of the present subject matter, a privacy protection system for recommendation services comprises middleware processor and a middleware memory coupled to the middleware processor. The middleware memory comprises a interest group aggregator module having at least one interest group aggregator, each of the at least one interest group aggregator configured to collate a plurality of segments of profile information pertaining to a plurality of end users categorized in a interest group based on a interest profile of each of the plurality of end users.

In accordance with another embodiment of the present subject matter, a privacy protection system for recommendation services comprises a client processor and a client memory coupled to the client processor. The client memory comprises an interest group identity computation module configured to determine at least one interest group id based on an interest profile of an end user of the client device, wherein the at least one interest group id represent at least one pre-defined interest group. In said embodiment, the client device is further configured to anonymously transmit the at least one interest group id and the interest profile of the end user to a privacy protection middleware system.

In accordance with another embodiment of the present subject matter, a computer readable medium having a set of computer readable instructions that, when executed, perform acts including aggregating profile information associated with a plurality of interest profiles of one or more end users who have been categorized into various interest groups based on the end users' interest profiles, determining one or more services availed by the at least one interest group based on the aggregated profile information and receiving recommended services for various interest groups based in part on the one or more availed services

In accordance with another embodiment of the present subject matter, a computer readable medium having a set of computer readable instructions that, when executed, perform acts including determining at least one interest group identity (id) based on an interest profile of an end user, wherein the at least one interest group identity pertains to at least one pre- defined interest group and anonymously transmitting profile information associated with the interest profile of the end user to an interest group aggregator module associated with the at least one interest group identity

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network environment implementation of a privacy protection system for recommendation services, in accordance with an embodiment of the present subject matter;

FIG. 2 illustrates an exemplary privacy protection system, according to one embodiment of the present subject matter;

FIG. 3 illustrates an exemplary method for privacy protection in recommended services, in accordance with an embodiment of the present subject matter; and

FIG. 4 illustrates an exemplary method for privacy protected recommended services, in accordance with another embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

The present subject matter relates to privacy protection in recommendation services. Systems and methods related to privacy protection of end users in recommendation services are described herein. In one embodiment, the present subject matter discloses a system and a method for privacy protection to protect confidential and personal information of the end users using their client devices to avail services or view content recommended by a service provider through a network.

Conventionally, the service provider attempts to personalize the services, such as services of providing content such as videos, audio, news, etc., based on preferences and choices of the end users. For this purpose, the service provider use techniques, such as content based recommendation and/or collaborative recommendation to recommend services, contents, or products that might be of interest to the end users based either on the past actions of the end users or past preferences by other users who have been identified to have similar interests as the end users.

For example, in the conventional content based recommendation approach if an end user, say user A, has purchased a book written by a particular author, the service provider may suggest the user A to purchase other books written by the same author or other books on the same or related subjects, etc.

In another conventional approach, namely the collaborative recommendation approach, the service provider determines other end users who may have an interest profile similar to an end user and recommend contents, or products that have been preferred by the other end users to the end user services. For the purpose, creation of interest profiles of a plurality of end users and matching the interest profiles of the end users to ascertain interest groups of end users who have similar interests is carried out using conventionally known methods. Details conventionally known in the art are omitted for the sake of brevity.

For example, if an end user, say user B, is interested in adventure sports, the service provider tries to find other end users who are also interested in adventure sports. If any of the other end users who are interested in adventure sports perform any activity, the service provider would suggest the user B to perform the same activity, even though user B may not have explicitly expressed his interest in the activity. This conventional approach assumes that end users, who have similar interest profiles, i.e., similar interests, have a high probability of having the same personal preferences.

The conventional techniques implemented by the service provider require collection of information related to personal preferences, choices, etc., of the end users. Conventionally, the service providers monitor and collect information pertaining to the end users through various means, such as by analyzing log files, application history files or other personally identifiable information saved on the end user's client device. In another conventional technique, the service provider may save a text file, such as a Hyper Text Transfer Protocol (http) cookie to collect information pertaining to an end user. For example, a web portal may save a http cookie of a web browser of an end user to store the preferences of the end user such as font size, arrangement of display widgets, etc. Further, the http cookie may also store the browsing details of the end user and send the same to the web portal.

Thus, in an attempt to provide recommendation services or personalized content, services or products to the end user based on the end user's personal choice, the service provider often monitors and collects information pertaining to the activity of the end user. In certain situations, it becomes possible to identify the end user on the basis of the information collected by the service providers. This may result in compromising the personal or confidential information of the end user and exposes the end user to potential privacy breaches or makes him the target of advertisers or spammers, etc. Further, in extreme cases, the end user may be a victim of various crimes such as identity theft, credit card frauds, etc.

The present subject matter discloses methods and systems for privacy protection of the end users using client devices to avail recommendation services i.e. recommendations to avail personalized or customized content, services or products provided by a service provider either directly or through a network. The systems and methods can be implemented in a variety of computing devices. In one embodiment, a privacy protection system for recommendation services includes a plurality of client devices and a privacy protection middleware system.

In one embodiment, a profile generation module is installed in the client device of the end user. Examples of such client devices include, but are not restricted to, computing device, such as mainframe computers, workstations, personal computers, desktop computers, minicomputers, servers, multiprocessor systems, and laptops; cellular communicating devices, such as a personal digital assistant, a smart phone, a mobile phone; and the like. The profile generation module may be implemented as a software tool, firmware, application plug-in, etc. The profile generation module generates an interest profile of the end user based on the personal choices and preferences of the end user. In one implementation, the profile generation module may interact with various applications through an application programming interface (API) to determine the personal choices and preferences. For example, the profile generation module may obtain information from the media players regarding video and audio files played by an end user, or the profile generation module may obtain the browsing history of the end user from the web browser and so on. In one implementation, the profile generation module may store the information pertaining to the end user as a set of key-value pair, where the key stores items, or category or tags associated with the items. For example, metadata associated with items like websites, songs, videos, etc., is stored as keys. At the same time, the value corresponding to a key is also stored. The valve is indicative of an interest level of the end user in the corresponding key.

The various sets of key-value pair are accessed by a group identity computation module running on the client device of the end user. The group identity computation module analyzes the various sets of key-value pair to determine a probable group to which the end user may pertain to. For example, in one implementation, the group identity computation module may generate meta-tags based on the various sets of key-value pair. These meta-tags may be compared to a pre-defined list of interest groups and a group identity (id) indicative of the group to which the end user pertains to may be determined. End users who have similar or same interests are categorized into the same group using conventional techniques such as local sensitivity hashing (LSH) techniques or semantic based clustering, etc. Further an end user may be categorized into one or more interest groups. For example, an end user C, interested in items X and Y, may be categorized into a group represented by say group id 100, wherein another end user, user D interested in items X, Y, and Z, may be categorized into say two interest groups represented by say group id 100 and 200. It should be appreciated that all the processing done by the profile generation module and the group identity computation module and data generated as a result thereof is not transmitted outside the client device of the end user.

The client device of the end user is connected to the privacy protection middleware system either directly or through the network. In one embodiment, the privacy protection middleware system may be one or more workstations, personal computers, desktop computers, multiprocessor systems, laptops, network computers, minicomputers, servers and the like. In another embodiment, the privacy protection middleware system may comprise a plurality of nodes, such as nodes pertains to the computing resources of one or more client devices, and wherein the privacy protection middleware system is implemented in a grid computing or cloud computing environment. In yet another embodiment, the privacy protection middleware system may also be implemented in the client device of any end user, say of user M, with the other end users connecting to the client device of the user M, as nodes, either directly or over a network such as a peer to peer (P2P) network. Further, the privacy protection middleware system may also run on nodes donated by or hosted by one or more non-colluding third parties.

The group identity computation module of the client device of the end user transmits the interest profile of the end user to a group aggregation module of the privacy protection middleware system. To ensure anonymity of the end user with respect to the privacy protection middleware system, in one embodiment, the group identity computation module may use a profile slicing technique. In profile slicing, the group identity computation module transmits the profile information, i.e., the information associated with the interest profile of the end user, to the privacy protection middleware system in multiple small segments. The group identity computation module is configured to slice the profile of the end user in multiple segments in such a way that a segment by itself cannot be analyzed to identify the end user. Further, since each interest profile is segmented the privacy protection middleware system receives the profile information in parts and is unable to integrate multiple segments to derive the complete profile. Thus preserving the profile privacy at the client devices.

Further, the privacy protection middleware system anonymously receives the profile information so as to ensure the client device is unidentifiable. In one implementation, the profile information transmitted to the privacy protection middleware system, either in segments or completely, is not linkable to the client device that sent the profile information. This again ensures that the privacy protection middleware system has no access to the interest profile of the end users. In another implementation, the group identity computation module transmits information related to the end user to the privacy protection middleware system using onion routing. Onion routing is a technique for anonymous communication over the network. In the onion routing technique data packets are repeatedly encrypted and then sent through several network nodes called onion routers. Each onion router removes a layer of encryption to uncover routing instructions, and sends the data packet to the next router where this is repeated. This prevents these intermediary nodes from knowing the origin, destination, and contents of the data packet. The said implementation ensures that the client device transmitting the profile information is unidentifiable with respect to the privacy protection middleware system. In one embodiment, the group identity computation module may employ both profile slicing and onion routing to ensure that the end user is not identified by the group aggregation module.

The privacy protection middleware system stores the information transmitted by a plurality of group identity computation module of multiple client devices coupled to it. The group aggregation module analyzes the information and collates the key-value pair transmitted by the group identity computation module. For example, the group aggregation module may anonymously aggregate the interests of all the end users who pertain to a particular group by collating the keys obtained from the end users pertaining to the particular group based on conventional techniques. Based on the collation, the privacy protection middleware system determines the preferred content, product or services within a group. For example, in one implementation, the privacy protection middleware system may generate a popularity graph to determine a certain pre-defined number of preferred content, product or services within a group.

The privacy protection middleware system is connected to one or more service providers, either directly or over the network. In one implementation, the group aggregation module emulates one or more end users to the service provider having an interest in the certain number of preferred content, products, or services within one or more interest groups. In said implementation, the group aggregation module can communicate the preferred interests of one or more interest groups in terms of content, products or services to the service provider. In response, the service provider may return a list of recommendations for contents or products or services, etc.

In another implementation, the group aggregation module seamlessly interacts with the service provider by posing as an end-user who consumes the preferred items of the one or more interest groups or the entire list of content or products, or services of the end users who are members of the one or more interest groups. The service provider may profile the group aggregation module, just as it profiles an end-user, and generates recommendations.

The recommendations obtained by the privacy protection middleware system are conveyed to the end users. In one implementation, the conventional techniques may be implemented to ensure that there is no breach of privacy during the transmission of information from the privacy protection system to the client device. In other words, it is ensured that the group aggregation module is unaware of the client devices to which the recommendations are transmitted. In one implementation, a local recommendation module running on the client device of the end user may be configured to regularly check with the privacy protection middleware system for availability of recommendations, also referred to as anonymous lookup. In another implementation, the privacy protection middleware system may be configured to anonymously publish the new recommendations by pushing the new recommendations, obtained based on the interest groups in which the end users have been categorized in, to the local recommendation module.

The local recommendation module running on the client device of the end user analyzes the recommendations received from the privacy protection middleware system and filters the content, service or products already viewed or availed by the end user and presents filtered recommendations or customized recommendations to the end user. In one implementation, the local recommendation module may filter the recommendations received from the privacy protection middleware system based on the interest profile of the end user to derive the filtered recommendations. Thus, the privacy protection middleware system facilitates the end user to avail various personalized services/content without revealing sensitive or confidential personal information.

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action.

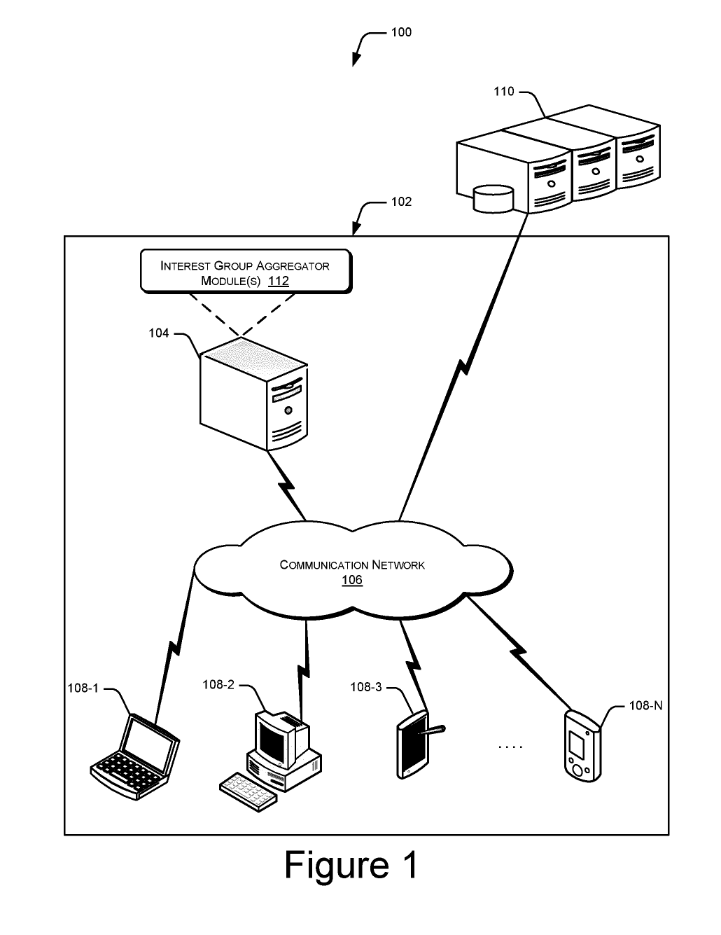

FIG. 1 illustrates a network environment 100 implementation of a privacy protection system 102 for recommendation services, in accordance with an embodiment of the present subject matter. The privacy protection system 102 described herein, can be implemented in any network environment comprising a variety of network devices, including routers, bridges, servers, computing devices, storage devices, etc. In one implementation the privacy protection system 102 includes a privacy protection middleware system 104 and one or more thin clients (not shown in the figure). The privacy protection middleware system 104 can be implemented as a variety of computing devices such as a laptop computer, a desktop computer, a notebook, a workstation, a mainframe computer, a server and the like.

The privacy protection middleware system 104 is connected through a communication network 106 to the one or more thin clients. It will be appreciated, that the thin clients are applications or functional modules that run on a variety of client devices 108-1, 108-2, 108-3, . . . , 108-N, henceforth referred to as client device(s) 108. The client devices 108 are used by end users to avail services or view content provided by a service provider 110. The client devices 108 may include computing devices, such as a laptop computer, a desktop computer, a notebook, a mobile phone, a personal digital assistant, a workstation, a mainframe computer, a set top box, and a media player. The client devices 108 facilitate the end users to exchange information with the privacy protection middleware system 104 either directly or over the communication network 106. The communication network 106 may be a wireless network, a wired network, or a combination thereof. The communication network 106 can be a combination of individual networks, interconnected with each other and functioning as a single large network, for example, the Internet or an intranet. The communication network 106 may be any public or private network, including a local area network (LAN), a wide area network (WAN), the Internet, an intranet, a peer to peer network and a virtual private network (VPN) and may include a variety of network devices such as routers, bridges, servers, computing devices, storage devices, etc. The privacy protection middleware system 104 is connected to the service provider 110 either directly or over the communication network 106.

In operation, interest profiles of the end users based on the activities of the end users are generated and are saved locally. For example, the interest profiles of the end users may be generated based on profile information corresponding to the end users. The profile information, for example, may indicate websites visited by the end users, songs or videos played or downloaded by the end users, products used or services availed or reviewed by the end users, etc. Based on the generated interest profile, the client device categorizes the end user in one or more pre-defined interest groups. Interest groups may be understood as groups of end users sharing similar interests and choices.

Based on the one or more of the pre-defined interest groups identified for the end users, the client devices 108 transmit the relevant profile information corresponding to the end users to one or more group aggregator module(s) 112 of the privacy protection middleware system 104. For example, based on the profile information, the end users may have been categorized into several interest groups, such as movies, sports and ebooks. In such a situation, the profile information of any end user pertaining to movies may be sent to the group aggregator module(s) 112 associated with a movies interest group aggregator, while the profile information pertaining to sports and ebooks may be sent to a sports interest group aggregator and an ebooks interest group aggregator (not shown in the figure) associated with sports and ebooks respectively. As apparent, the group aggregator module(s) 112 may include multiple interest group aggregators, where each interest group aggregator is associated with one interest group. Although in the depicted embodiment, various interest group aggregators are integrated within the group aggregator module(s) 112, it will be appreciated that in various other embodiments, such interest group aggregators may be discrete modules implemented on one or more computing devices.

The client devices 108 transmit the profile information pertaining to the one or more of the interest groups to the group aggregator module(s) 112, without compromising the privacy of the end users using various techniques described later in the specification. The group aggregator module(s) 112 collates the profile information of the end users pertaining to each interest group. Thereupon, the preferred categories of services availed by the end users belonging to each interest group is determined and provided to the service provider 110 to obtain recommendation from the service provider 110. The recommendations are generated by the service provider 110 based on the conventional techniques such as content based recommendation, collaborative recommendation, etc. Thus, instead of the end users directly interfacing with the service provider 110 to avail recommendation services, the group aggregator module(s) 112 presents the end users or a group of end user having a certain interest profile to the service provider 110 and avails the recommendation services, ensuring the privacy of the end users associated with the group aggregator module(s) 112.

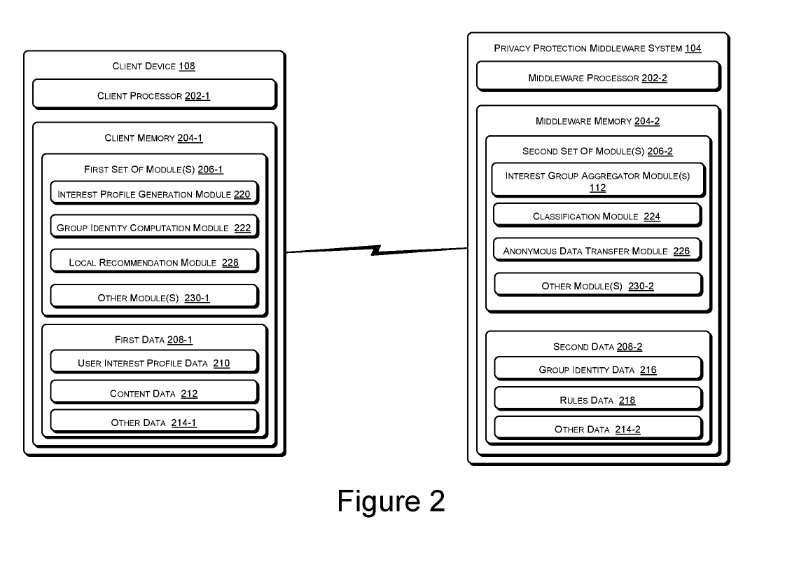

The client devices 108 receive the recommended services from the privacy protection middleware system 104. It is ensured using various techniques, described later in the specification, that the privacy protection middleware system 104 is unaware of the specific client devices 108 to which the recommended services are forwarded. In one implementation, the client device 108 may be configured to further process the received recommended services based on the interest profile corresponding to the end users so as to generate a customized recommendation of services for the end users. Details of implementation of the client device 108 and the privacy protection middleware system 104 have been described in conjunction with FIG. 2 later in the specification.

The privacy protection system 102 enables the end users to avail personalized recommendations without disclosing their confidential profile information to the service provider 110. Further, the privacy protection system 102 supports third party content and recommendation injection without compromising on the privacy of the end users.

FIG. 2 illustrates the exemplary privacy protection system 102. As mentioned earlier, in one implementation the privacy protection system 102 includes the privacy protection middleware system 104 and the client device 108, in accordance with an embodiment of the present subject matter. In one embodiment, the client device 108 includes a client processor 202-1, and a client memory 204-1 connected to the client processor 202-1. In one implementation, the privacy protection middleware system 104 includes a middleware processor 202-2 and a middleware memory 204-2 connected to the middleware processor 202-2. The client processor 202-1 and the middleware processor 202-2 are collectively referred to as the processor(s) 202 and the client memory 204-1 and the middleware memory 204-2 are collectively referred to as the memory 204.

The processor(s) 202 may include microprocessors, microcomputers, microcontrollers, digital signal processors, central processing units, state machines, logic circuitries and/or any other devices that manipulate signals and data based on operational instructions. The processor(s) 202 can be a single processing unit or a number of units, all of which could also include multiple computing units. Among other capabilities, the processor(s) 202 are configured to fetch and execute computer-readable instructions stored in the memory 204.

Functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The memory 204 can include any computer-readable medium known in the art including, for example, volatile memory, such as RANI and/or non-volatile memory, such as flash. The client memory 204-1 of the client device 108 further includes a first set of module(s) 206-1 and a first data 208-1. Similarly the middleware memory 204-2 of the privacy protection middleware system 104 includes a second set of module(s) 206-2 and a second data 208-2. The first set of module(s) 206-1 and the second set of module(s) 206-2 include routines, programs, objects, components, data structures, etc., which perform particular tasks or implement particular abstract data types.

On the other hand, the client device 108 includes the first data 208-1 which, amongst other things, serves as a repository for storing data processed, received, associated and generated by one or more of the first set of module(s) 206-1. The first data 208-1 includes, for example, a user interest profile data 210, a content data 212, and other data 214-1. The other data 214-1 may include data and temporary information generated as a result of the execution of one or more modules in the first set of module(s) 206-1.

The privacy protection middleware system 104 includes the second data 208-2 which, amongst other things, serves as a repository for storing data processed, received, associated and generated by one or more of the second set of module(s) 206-2. The second data 208-2 includes, for example, a group identity data 216, a rules data 218, and other data 214-2. The other data 214-2 may include data and temporary information generated as a result of the execution of one or more modules in the second set of module(s) 206-2.

Further both the privacy protection middleware system 104 and the client device 108 includes one or more interface(s) (not shown in the figure). The interface(s) may include a variety of software and hardware interfaces, for example, interface(s) for peripheral device(s) such as data input output devices, referred to as I/O devices, storage devices, network devices, etc. The I/O device(s) may include Universal Serial Bus (USB) ports, Ethernet ports, host bus adaptors, etc., and their corresponding device drivers. The interface(s) facilitate the communication of the privacy protection middleware system 104 and the client device 108 with various networks such as the communication network 106 and various communication and computing devices.

In one implementation, the client device 108 includes an interest profile generation module 220. The interest profile generation module 220 is configured to generate an interest profile of the end user of the client device 108 based on his activities or consumption history of services. In one implementation, the interest profile generation module 220 may analyze the content viewed or services availed of by the end user to generate a set of key-value pair. In one implementation, a key of the key-value pair stores one or more classification name or tags or metadata associated with the content or service and a value of the key-value pair stores a weightage indicative of the interest level of the end user in the content or service represented by the key.

For example, the service provider 110, say, a Video-on-Demand (VoD) portal, may associate each content item, such as video files, with the content item's metadata. The metadata may include title of the video files and/or artists and/or genres and/or keywords/tags describing the video files, etc. The interest profile generation module 220 analyzes the metadata associated with video files played by the end user and generates the set of key-value pair, where the key would store the metadata associated with the video file and the value would indicate the interest level of the end user towards the video file.

In another implementation, the content may be a web page. The interest profile generation module 220 may analyze the web page so as to generate metadata associated with the web page. For example, the interest profile generation module 220 may analyze the uniform resource locator (URL) of the web page to generate the metadata associated with the web page. Further the interest profile generation module 220 may be configured to analyze one or more hypertext markup language (HTML) tags such as “title”, “meta”, etc., by parsing the source text of the web page to generate the metadata. Moreover, the interest profile generation module 220 may also perform additional normalization techniques wherein certain HTML tags may be assigned more weightage than certain other HTML tags. Based on the metadata so generated, the interest profile generation module 220 may generate the sets of key-value pair for the end user. It should be appreciated by those skilled in the art that the keys of the sets of key-value pair may store the name or the title of the content title as well as metadata such as genres or tags which characterize the content.

In another implementation, the interest profile generation module 220 may be configured to generate a triplet of “item-category, item-list and value”, where the item-category represents categories or metadata associated with a content or service and the item-list indicates the content name or title and the value indicates the interest level of the end user. The interest profile generation module 220 consolidates the sets of key-value pair or the triplets of “item-category, item-list and value” to generate an interest profile of the end user which is saved as the user interest profile data 210.

A group identity computation module 222 analyzes the interest profile of the end user. Based on the analysis, the group identity computation module 222 categorizes the end user into one or more pre-defined interest groups comprising end users having similar interests by mapping the interest profile of the end user with meta tags associated with the one or more pre-defined interest groups. In one implementation, the group identity computation module 222 implements conventional techniques such as local sensitivity hashing (LSH) techniques or semantics-based clustering to determine the group ids indicative of the one or more interest groups to which the end user pertains. In LSH technique, two similar objects hash to the same value with a high probability. The group identity computation module 222 is configured to use the value generated by the hash functions as the label or the group id of the group of end users having similar interests, i.e. end users having similar interest profiles. Further as stated before, the group identity computation module 222 may assign more than one group id to an end user so as to cover several aspects of the end user's interest profile.

In another implementation, the group identity computation module 222 may generate a list of a certain number of preferred categories of services availed of by the end user as indicated in the end user's interest profile. The group identity computation module 222 is configured to consider a list of preferred categories of services availed of by the end user group ids of the one or more interest groups to which the end user pertains to. In another configuration, the group identity computation module 222 may generate different subsets of preferred categories of services availed of by the end user, so that the end user pertains to more than one interest group.

The group identity computation module 222 anonymously transmits the interest profile of the end user to the group aggregator module 112 of the privacy protection middleware system 104. As explained previously, the group identity computation module 222 may assign more than one group id to the end user so as to cover several aspects of the end user's interest profile. As also explained previously, the group aggregator module(s) 112 may comprise multiple interest group aggregators, wherein each interest group aggregator is associated with one interest group, and wherein the group id is indicative of the interest group. Thus, based on the group id, the group identity computation module 222 identifies interest group aggregators pertaining to the various interests of the end user and sends to each of these interest group aggregators the profile information relating to the interest to which the these interest group aggregators relate. It will be appreciated that the profile information relating to a given interest to is derived from the interest profile of the end user generated by the interest profile generation module 220.

The group identity computation module 222 implements various techniques so as to ensure privacy of the end user. In one implementation, the group identity computation module 222 implements profile slicing to ensure the anonymity of the end user. In said implementation, the group identity computation module 222 slices the profile information of the end users in multiple segments, each segment comprising of one or more sets of key-value pair. The group identity computation module 222 ensures that no segment of the profile information of the end user by itself contains enough profile information that can be used to construct the complete interest prolife and infer the identity of the end user.

Further, each segment of the end user interest profile and the group ids, indicative of the interest groups in which the end user has been characterized in, are sent by the group identity computation module 222 over a network employing mechanisms which ensures anonymity, for example, a network implementing onion routing. In one implementation, an onion-routing path is established wherein the group identity computation module 222 encrypts the segment of the profile information and the group ids pertaining to the end user with the public-key of an exit node of the onion-routing path. The various segments of the profile information and the group ids pertaining to the end user are transmitted over one or more intermediate nodes before reaching the exit node. The exit-node decrypts the information and transmits the same to the group aggregator module 112. In one embodiment, the group identity computation module 222 may be configured to select a random set of distributed hash table (DHT) nodes to transmit the segments of the profile information of the end user to ensure that none of the nodes are identifiable as sources. In case the client device 108, say an IPTV set top box, the IPTV set top box can be configured to be a node of the DHT network and other conventional techniques, such as anonimyzing peer to peer proxy (AP3), may be implemented ensure the privacy of the user.

The group aggregator module 112 aggregates all the segments of profile information pertaining to multiple end users who have been categorized to be in the same interest group based on their interests. In one implementation, the group aggregator module 112 may save the same as group identity data 216. A classification module 224 of the privacy protection middleware system 104 analyzes the aggregated data pertaining to each group to determine a list of the preferred services or categories of services or tags associated with services with each interest group. The list of the preferred services, categories of services or tags associated with services indicates the interests of the interest group comprising multiple end users, as a whole. In one implementation, the classification module 224 may be configured to generate a popularity graph to determine a certain number, say N, of preferred services or categories of services or tags associated with services within the interest group.

In one embodiment, the classification module 224 may be configured to explicitly pull recommended services from the service provider 110 on behalf of the interest group. In this embodiment, the classification module 224 communicates the preferred interests of the group in terms of categories or tags to the service provider 110 to obtain recommendations. The service provider 110 returns a list of recommended services in accordance with the interest of the group.

Alternatively the classification module 224 may also be configured to emulate an end user so that the classification module 224 can interact seamlessly with the service provider 110. In said configuration, the classification module 224 emulates as an end-user who avails the preferred services or all the services of the end users categorized in the interest group. The service provider 110 profiles the classification module 224 just as any other end user, and generates recommendations for the classification module 224, which actually represent the recommendations for the end user pertaining to the group based on the interests of the end user. Thus, the classification module 224 emulates the end user to the service provider 110. As apparent, the group aggregator module(s) 112 enable the classification module 224 to emulate the end user to the service provider 110.

An anonymous data transfer module 226, henceforth referred to as the ADTM 226, is configured to transmit the recommendations generated by the service provider 110, without breaching the privacy of the end user, to a local recommendation module 228 of the client device 108.

In one configuration, the local recommendation module 228 of the client device 108 is configured to periodically check the ADTM 226 for any new services. In said configuration, the local recommendation module 228 generates a first distributed hash table (DHT) lookup by using the group id associated with the interest group aggregator as a unique identifier. In one implementation, the DHT lookup is done over an onion-routing path, where the group id is encrypted with the public-key of the exit node of the onion-routing path. The exit-node decrypts the group id and generates a second DHT lookup with group id as the key based routing (KBR) identifier. Key based routing is a lookup method used in conjunction with DHTs and certain overlay networks. In general, DHTs provide a method to find a node responsible for a certain piece of data whereas KBR provides a method to find the closest host for that data, according to some defined metric such as number of network hops, etc.

The results of the second DHT lookup are encrypted by the exit node with the symmetric encryption key that is provided by the local recommendation module 228. The encrypted results are sent back on the reverse onion routing path and the end-user's local recommendation module 228 decrypts the encrypted results to obtain the recommendations generated by the service provider 110.

In another implementation, the recommendations by the classification module 224 are published to the end users of a group by the ADTIVI 226. In one embodiment, to ensure that the privacy of the end user is not breached anonymous channels are used. The anonymous channels facilitate the local recommendation module 228 to specify an address or location, say a kind of mailbox-address, for receiving the recommended services, as the channel address without revealing the end user's identity.

On receiving the recommendations generated by the service provider 110, the local recommendation module 228 compares them with the interest profile of the end user. For example, in one implementation, the local recommendation module 228 removes the services already availed by the end user from the recommendations generated by the service provider 110 service and merges the remaining recommendations generated for each group in which the end user has been categorized in. In said implementation, the services already availed by the end user may be retrieved from the content data 212. In another implementation, the local recommendation module 228 may be configured to filter the recommendations generated by the service provider 110 based on the interest profile of the end user to derive the filtered recommendations.

Further in another embodiment both the client device 108 and the privacy protection middleware system 104 may include other module(s) 230-1 and 230-2 collectively referred to as other module(s) 230. The other module(s) 230 may include programs or coded instructions, such as operating systems, that supplement applications and functions of the privacy protection middleware system 104 and the client device 108.

Thus, the privacy protection system 102 comprising the client device 108 and the privacy protection middleware system 104 that facilitate the end user to obtain recommended content or services based on the end user's interest without revealing the end user's identity or compromising the end user's privacy.

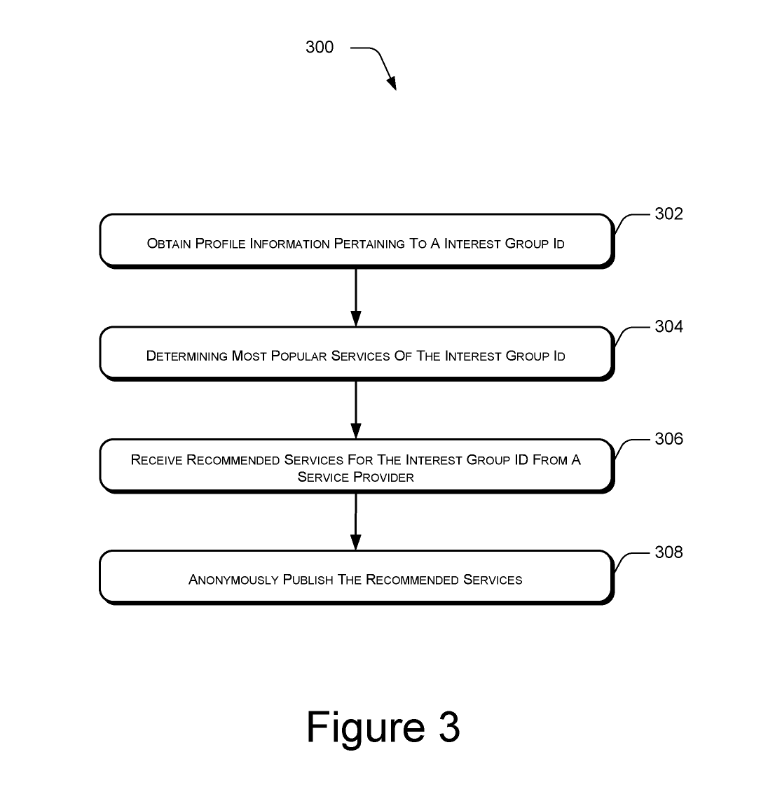

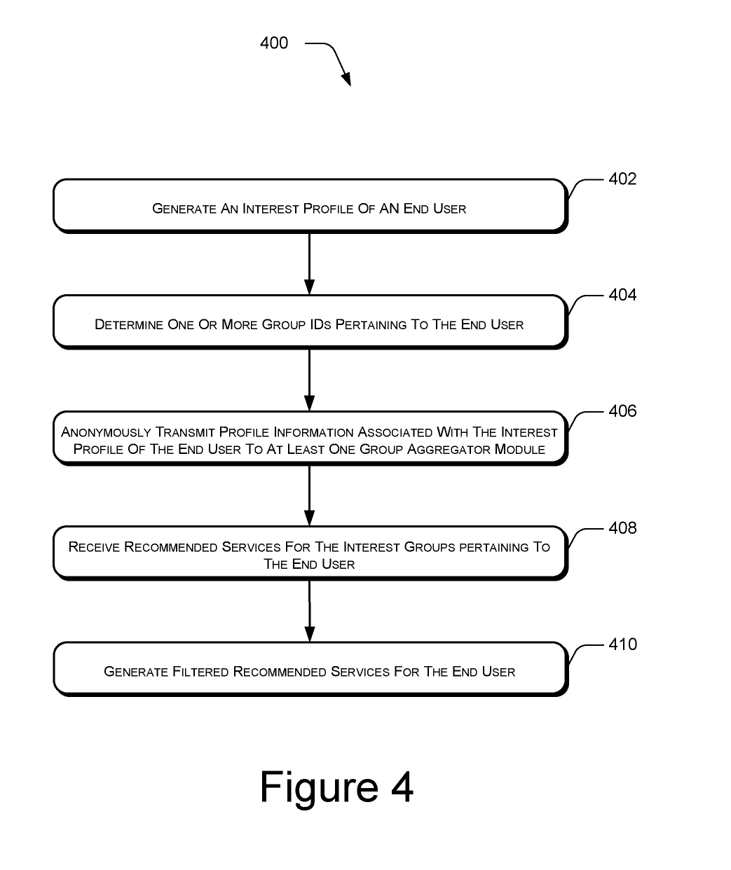

FIG. 3 and FIG. 4 illustrate exemplary methods 300 and 400 for providing privacy protection in recommended services, in accordance with an embodiment of the present subject matter. Although the methods 300, and 400 as described in FIG. 3, and FIG. 4 as described in FIG. 4, are explained in context of the privacy protection middleware system 104 and the client devices 108 of the privacy protection system 102, respectively, it will be understood that the same may be extended to other system and devices without deviating from the scope of the present subject matter.

The order in which the methods 300 and 400 are described is not intended to be construed as a limitation, and any number of the described method blocks can be combined in any order to implement the methods, or alternative methods. Additionally, individual blocks may be deleted from the methods without departing from the spirit and scope of the subject matter described herein. Furthermore, the methods can be implemented in any suitable hardware, software, firmware, or combination thereof.

A person skilled in the art will readily recognize that steps of the methods 300 and 400 can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described methods. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary methods.

Referring to FIG. 3 illustrating the method 300, at block 302, data pertaining to a group id indicative of an interest group of end users having same or similar interests is received by the privacy protection middleware system 104. The data comprises segmented profile information of interest profiles of the end users who have been categorized in the interest group represented by the group id. Privacy protection techniques, such as profile slicing as elaborated earlier, make it unfeasible for the privacy protection middleware system 104 to analyze the data so as to determine the identity of the end users. As illustrated in block 304, the privacy protection middleware system 104 collates the data to determine the preferred services or preferred categories or tags associated with the services availed of by the end users who have been categorized in the interest group represented by the group id. For example, the data may be used to generate a popularity graph to determine a certain number of preferred categories of service of the interest group as a whole.

The privacy protection middleware system 104, thereupon interfaces with the service provider 110 to receive recommended services from the service provider 110 based on the preferred categories of content/ service of the group, as depicted in block 306. In one implementation, the privacy protection middleware system 104 communicates the preferred categories of service of the interest group to the service provider 110 and obtains recommended services from the service provider 110. In another implementation, the privacy protection middleware system 104 may pose as the end user who consumes the preferred categories of service of the group so that the service provider 110 may profile the privacy protection middleware system 104 as any end user and generate recommended service for the privacy protection middleware system 104. As shown in block 308, in one implementation, the privacy protection middleware system 104 anonymously publishes the recommended services generated by the service provider 110 to the end users of the interest group.

Referring to FIG. 4 that illustrates the method 400, at block 402, a client device 108 of an end user generates an interest profile of the end user based on the end user's activity so as to determine the interests, preferences or choices of the end user. For example, the client device 108 may accumulate data pertaining to websites visited by the end user, media files played by the end user, articles read by the end user, places checked into by the end user, etc., so as to generate the interest profile the end user. As illustrated in block 404, the client device 108 determines one or more group ids, indicative of one or more interest groups of end users having similar interests or choices, in which the end user may be categorized in. As mentioned before, conventional techniques such as LSH techniques, semantic clustering, etc., are implemented to determine the group ids of interest groups comprising of end users having similar interests or choices.

As depicted in block 406, the client device 108 anonymously transmits profile information of the end user related to an interest group in which the end user has been categorized, to an interest group aggregator of the privacy protection middleware system 104 based on the group id. Various techniques, such as interest profile slicing as elaborated earlier, are used to ensure that privacy of the end user is not compromised. Further the segments of the profile information of the end user, generated as a result of profile slicing, are communicated over an onion routing path making it impossible for the privacy protection middleware system 104 to trace back or determine the identity of the end user.

As illustrated in block 408, the client device 108 obtains recommended services for the interest group pertaining to the end user. In one implementation, the client device 108 regularly checks the privacy protection middleware system 104 so as to receive new recommendations of services for the end user. At block 410, the client device 108 may further process the recommendations received from the services provider 110, from example, by removing services already consumed by the end user, merging recommendations for all the group ids pertaining to the end user, etc., to generate a filtered list of recommended services for the end user.

Although implementations for privacy protection system have been described in language specific to structural features and/or methods, it is to be understood that the appended claims are not necessarily limited to the specific features or methods described. Rather, the specific features and methods are disclosed as exemplary implementations for privacy protection in recommended services.

1. A method for privacy protection in recommended services, the method comprising:
aggregating profile information associated with a plurality of interest profiles of one or more end users, wherein the one or more end users are categorized into at least one interest group based on the associated interest profiles;
determining one or more services availed by the at least one interest group; and
receiving recommended services for the at least one interest group based in part on the one or more services.

2. The method as claimed in claim 1 further comprising receiving the profile information associated with the plurality of interest profiles in multiple segments.

3. The method as claimed in claim 1 further comprising receiving the profile information associated with the plurality of interest profiles from at least one client device, wherein the at least one client device sending the profile information is unidentifiable.

4. The method as claimed in claim 1, wherein the receiving further comprises providing the one or more services availed by the at least one interest group to a service provider, wherein the service provider provides the recommended services based on one or more of a content based recommendation technique and a collaborative recommendation technique.

5. The method as claimed in claim 1 further comprising providing anonymously the received recommended services to at least one client device, such that the at least one client device to which the recommended services is provided is unidentifiable.

6. A method for privacy protected recommended services, the method comprising:
determining at least one interest group identity based on an interest profile of an end user, wherein the at least one interest group identity pertains to at least one pre-defined interest group; and
transmitting anonymously profile information associated with the interest profile of the end user to an interest group aggregator module associated with the at least one interest group identity.

7. The method as claimed in claim 6 further comprising generating the interest profile of the end user to ascertain profile information pertaining to the at least one interest group identity.

8. The method as claimed in claim 6 further comprising slicing the profile information of the end user into a plurality of segments.

9. The method as claimed in claim 8, wherein at least one of the plurality of segments is anonymously transmitted over an onion routing path.

10. A privacy protection system for recommendation services comprising:
a processor; and
a memory coupled to the processor, the memory comprising an interest group aggregator module having at least one interest group aggregator, wherein the at least one interest group aggregator configured to,
collate a plurality of segments of profile information pertaining to a plurality of end users categorized in the at least one interest group based on an interest profile of each of the plurality of end users.

11. The privacy protection system as claimed in claim 10 wherein the at least one interest group aggregator is a node in one of a cloud computing and grid computing environment.

12. The privacy protection system as claimed in claim 10 wherein the at least one interest group aggregator is a node pertaining to computing resources of the end user.

13. The privacy protection system as claimed in claim 10 further comprising a classification module configured to determine one or more preferred services for the at least one interest group.

14. The privacy protection system as claimed in claim 13 wherein the classification module is further configured to avail recommended services from a service provider based on the determination.

15. The privacy protection system as claimed in claim 10 further comprising an anonymous data transfer module configured to anonymously transmit recommended data to at least one client device of the plurality of end users.

16. A privacy protection system for recommendation services comprising:
a processor; and
a memory coupled to the processor, the memory comprises an interest group identity computation module configured to, determine at least one interest group id based on an interest profile of an end user of the client device, wherein the at least one interest group id represent at least one pre-defined interest group.

17. The privacy protection system as claimed in claim 16, wherein the interest group identity computation module is further configured to:
generate the interest profile of the end user based on content consumed by the end user; and
segment the interest profile of the end user into a plurality of segments, wherein profile information associated with each of the plurality of segments is transmitted anonymously to a privacy protection middleware system.

18. The privacy protection system as claimed in claim 16 further comprising a local recommendation module configured to:
receive recommended content from a privacy protection middleware system; and
filter the received recommended content based in part on the interest profile of the end user.

19. A computer-readable medium having embodied thereon a computer program for executing a method comprising:
aggregating profile information associated with a plurality of interest profiles of one or more end users, wherein the one or more end users are categorized into at least one interest group based on the associated interest profiles;
determining one or more services availed by the at least one interest group; and
receiving recommended services for the at least one interest group based in part on the one or more availed services.

20. A computer-readable medium having embodied thereon a computer program for executing a method comprising:
determining at least one interest group identity based on an interest profile of an end user, wherein the at least one interest group identity pertains to at least one pre-defined interest group; and
transmitting anonymously profile information associated with the interest profile of the end user to an interest group aggregator module associated with the at least one interest group identity.
